(19) United States
(12) Patent Application Publication
(10) Pub. No.: US 2007/0259119 A1
(43) Pub. Date: Nov. 8, 2007

(54) Thermal conductive coating layer, composition thereof and method for producing the same

(75) Inventor: Chien-Chi Shen, Taipei County (TW)

Correspondence Address: BIRCH STEWART KOLASCH & BIRCH, PO BOX 747, FALLS CHURCH, VA, 22040-0747, US

(73) Assignee: National Nitride Technologies Co., Ltd.

(21) Appl. No.: 11/584,780

(22) Filed: Oct. 23, 2006

(30) Foreign Application Priority Data
May 4, 2006 (TW) 95115873

(51) Int. Cl. B05D 3/02; B05D 1/02; B05D 1/28; B05D 1/18; C08K 3/38

(52) U.S. Cl. 427/372.2; 427/421.1; 427/430.1; 427/429; 524/404

(57) ABSTRACT

The present invention relates to a composition of thermal conductive layer and the preparing method thereof, which comprises forming a surface coating by a composition of boron nitride and binding reagent in order to enhancing the thermal disperse effect of the surface. It applies for the material surface of heat exchange metal blocks, piece materials, heat exchanger, metal back plate, metal and the plastic shell.

### FIELD OF THE INVENTION

The present invention is related with a coating layer for enhancing the thermal management effect on the surface. More particularly, the present invention relates to a composition and a method of preparing the thermal conductive coating layer.

### BACKGROUND OF THE INVENTION

Currently, since the microlization of electronic devices are developed such as MEMS (micro-electro mechanical system), the thermal management problems of the electronic devices have to be resolved. Overheated devices will lead to the failure of the operation and short usage-time of the device. Therefore, how to provide a novel material to raise the thermal dispersion or thermal conductive effect has become the main object of the MEMS development.

Thermal conductive mechanism is divided into active and passive ones. The active thermal conduction means applying gas or liquid medium of circling to remove heat from the surface of elements and the general active thermal conductive mechanism is either air cooling or water-pump cooling. However, the active thermal conductive elements are not suitable for low-loudness or small-volume equipments due to that the fan installation will produce sound and minimize the internal space to block air convection.

By means of heat conductive and well heat-dissipating material, it is able to make heat during the device operation transfer to the surrounded medium more effective by using some materials of good heat conducting and heat exchange properties This kind of passive thermal conductive mechanism is not as effective as the active ones, but is crucial in overcoming the limitation as mention above. Passive thermal conductive mechanism at present is to contact high temperature surface with a heat-dissipating element, the heat-dissipating element is made of heat conductive and well heat-dissipating material, moreover, through the design of large dimension appearance, it transfers the high temperature from the surface to the heat-dissipating element then conducts rapidly to the surrounded mediums, for example, some aluminum or copper heat sinks. The active and passive thermal conductive mechanism are capable of combining for application; the practical example is to cooperate the heat sink, which is provided with a fan in order to reduce the temperature for keeping it in the region of working temperature in CPU or drawing chip.

Further promoting the effect of passive thermal conductive mechanism, the present invention provides a coating layer, which is able to improve the thermal conductivity of coated surface by forming a coating layer on the surface in a simple coating method. It can be applied with the elements comprised well heat-dissipating material, for example, heat exchanging metal block, piece material, pin fin, the metal back plate of LCD back light module, metal or plastic shell.

Therefore, it is desirable to provide an improved speech recognition method to mitigate and/or obviate the aforementioned problems.

### SUMMARY OF THE INVENTION

The object of the present invention is to provide a coating layer of improving the surface thermal conductive effect in order to solve the problem of causing the high temperature when operating the micro electronic elements, moreover, the present invention provides a composition for manufacturing the thermal conductive coating layer, which is to form a coating layer by removing the reagent in the composition after forming a thin layer on the surface.

To achieve the above object, the thermal conductive coating layer of the present invention comprises 30-70% (w/w) boron nitride; and 30-70% (w/w) binding reagent.

In the preferred embodiment, the coating layer of present invention comprises 40-60% (w/w) boron nitride; and 40-60% (w/w) binding reagent.

The present invention also provides a composition of the thermal conductive coating layer, comprising: 1-45% (w/w) boron nitride; 1-45% (w/w) binding reagent; and a solvent.

In the preferred embodiment, the mentioned composition of the thermal conductive coating layer of present invention comprises: 1-45% (w/w) boron nitride; 1-30% (w/w) binding reagent; and a solvent.

Another preferred embodiment, the composition of the thermal conductive coating layer of present invention comprises 1-20% (w/w) boron nitride; 1-20% (w/w) binding reagent; and a solvent.

The composition of the thermal conductive coating layer of present invention further comprises a disperse agent.

The method for preparing a thermal conductive coating layer comprising the following steps: a) obtaining the mentioned composition; b) forming a coating layer of said composition on a substrate surface; and c) drying said coating layer.

The substrate comprises metal or polymer. For example, the metal is copper, aluminum or iron; the polymer is ABS or PC.

Other objects, advantages, and novel features of the invention will become more apparent from the following detailed description when taken in conjunction with the accompanying drawings.

### BRIEF DESCRIPTION OF THE DRAWINGS

FIG. 1 is a temperature variation of the aluminum coating with the thermal conductive coating layer of present invention versus the aluminum without the thermal conductive coating layer of present invention.

### DETAILED DESCRIPTION OF THE PREFERRED EMBODIMENT

The thermal conductive coating layer of the present invention includes 30-70% (w/w) boron nitride; and 30-70% (w/w) binding reagent. The binding reagent includes thermoplastic resins, thermo-setting resins or the mixture thereof. For example, the resin includes, but not limited to epoxy resin, phenolric resin, acrylic resin, polystyrene resin or the mixture thereof.

In the preferred embodiment, the coating layer of present invention comprises 40-60% (w/w) boron nitride; and 40-60% (w/w) binding reagent.

The thermal conductive layer was formed by coating a solution of boron nitride and binding reagent on the substrate surface with a predetermined layer thickness then remove the solvent in the solution. Therefore, the present invention also provides a composition of the thermal conductive coating layer, comprising: 1-45% (w/w) boron nitride; 1-45% (w/w) binding reagent; and a solvent.

In the preferred embodiment, the mentioned composition of the thermal conductive coating layer in the present invention comprises: 1-45% (w/w) boron nitride; 1-30% (w/w) binding reagent; and a solvent. More preferably, the composition of the thermal conductive coating layer of present invention comprises 1-20% (w/w) boron nitride; 1-20% (w/w) binding reagent; and a solvent.

The embodiment of the binding reagent comprises, but not limits to epoxy resin, phenolric resin, acrylic resin, polystyrene resin or the mixture thereof.

The aforesaid solvent possess the following characteristics: capable of mixing evenly with boron nitride and binding reagent but does not react with the both compositions or any other added components, easy to form with the binding reagent on the surface, and easily removed after forming on the surface, for example, water or the inert organic solvent. The example of the present invention comprises toluene as the solvent, so the water is not the only choice.

The composition of the present invention can be prepared by the method as follow: obtaining the mentioned composition, and then forming an even layer of a predetermined thickness on the surface. The coating method comprises, but not limits to spray coating, brush coating, or immersing. Of course, any other methods for forming a layer can be used in the present invention. Finally, dry the even layer and remove the solvent and then the thermal conductive layer of the present invention can be obtained. The drying method comprises, but not limit to heating or air dry. Any other methods for removing or drying the solvent can be used in the present invention.

The advantages of the present invention are further depicted in the illustration of examples, but the descriptions made in the examples should not be construed as a limitation on the actual application of the present invention.

### EXAMPLE 1

### Thermal Conductive Effect Testing of the Thermal Conductive Layer

### The Composition Applied to the Thermal Conductive Layer

1 kg toluene is taken to stir with 0.2 kg boron nitride for 30 minutes, then 0.24 kg epoxy resin is added, and stirred for an hour, grinded for another 4 hours in a ball mill, the composition of the thermal conductive layer is obtained.

### Surface Area

Firstly, 2 pieces of general aluminum (5 cm×5 cm×2 mm) are taken as the material of the heat sinks, one of them used as a control (without coating the thermal conductive layer) and the other one coated with the thermal conductive layer in the present invention with a thickness of 15 mm. The forming method of the coating layer is to spray the mentioned composition evenly on the aluminum piece and form a coating layer, then heated under 80° C. which is able to remove toluene. Thereafter, aforesaid aluminum piece is examined with Surface Area Measurement System (NOVA 2200), and it is obtained the aluminum surface area in 7156.53 cm² of the thermal conductive coating layer in the present invention. The surface area in aluminum piece of the control is 45.92 cm², obviously that the thermal conductive coating layer in the present invention is provided about 155 times of the control in the surface area, which is able to improve the efficacy of thermal conductivity.

### Examining the Thermal Conductive Efficiency

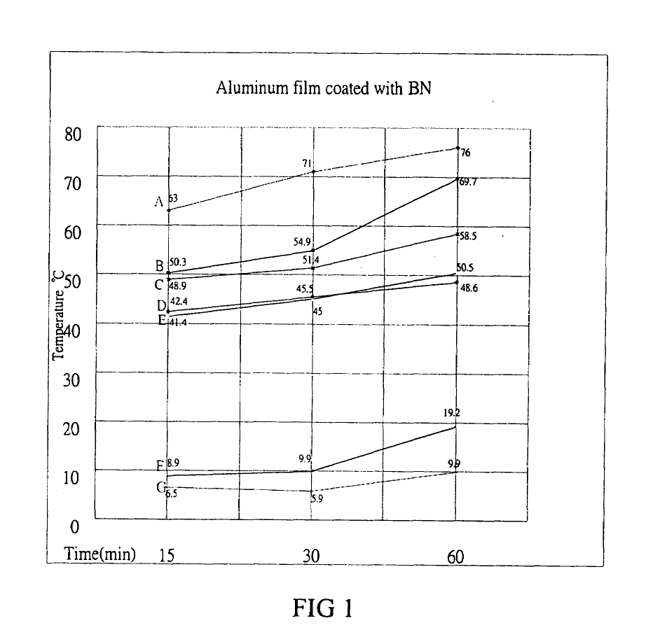

The mentioned 2 pieces are placed into the temperature and humidity chamber, attached to the heating pieces; the output power is fixed on 37.5 (V). The temperature variation process is observed and recorded, including raising speed, the highest temperature, the heat source temperature, the surface temperature of heat sink and the final constant temperature. The result is as shown in FIG. 1. In FIG. 1, the curve A is the variation curve of heat source temperature without using aluminum for assisting heat exchange; the curve B is the variation curve of temperature of the aluminum without coating with the thermal conductive layer in the present invention and then contacts with the heat source. The curve C is the variation curve of temperature of the aluminum coated with the thermal conductive layer in the present invention and contacts the heat source for assisting thermal disperse. Comparing to the three curves, the aluminum is able to assist the heat source for thermal disperse and achieve the effect of lowering temperature by time (30 minutes), but the thermal disperse effect without coating with the thermal conductive layer in the present invention diminishes (curve B) after the heat source temperature is continuously raising (60 minutes). The aluminum coated with the thermal conductive coating layer in the present invention, although doesn't provide with a better thermal conductivity effect in the earlier stage, it is obviously comprised with the thermal conductivity effect after the continuously raising of the heat source temperature (curve C).

Moreover, the curve D is the temperature variation of the aluminum of the thermal conductive coating layer in the present invention contact with the heat source, which assists the heat exchanging process, the curve E is the temperature variation of the aluminum without the thermal conductive coating layer in the present invention contact with the heat source, which assists the heat exchange process. Compared with curve D and E, it is known that when the heat source is in the low temperature, there is only small difference in the thermal disperse efficacy of the coated or not coated with the thermal conductive coating layer in the present invention, but when the heating temperature is raising by time, the aluminum without coated the thermal conductive layer in the present invention shows a higher temperature raising trend then which of the aluminum coated with the thermal conductive layer in the present invention.

In order to compare the property of the thermal conductive layer in the present invention more clearly, contrast curve F and G, wherein that the curve F is a ΔT graph of the surface temperature and the heat temperature difference, the aluminum without coating with the thermal conductive layer of the present invention contacts with the heating source, which assist heat exchange (the temperature of curve B−the temperature of curve E); the curve G is a ΔT graph of the surface temperature and the heat temperature difference, the aluminum coated with the thermal conductive layer in the present invention contacts with the heating source, which assist heat exchange (the temperature of curve C−the temperature of curve D). Compare to curve F and curve G, the aluminum coated with the thermal conductive layer in the present invention has a better thermal disperse effect than the aluminum without coated with the thermal conductive layer, the thermal conductive layer is able to speed up the thermal disperse effect of the aluminum, especially in high temperature.

To sum up, it is quickly reactive in the surface temperature of the aluminum piece coated with the thermal conductive layer in the present invention and the heat source of aforesaid aluminum piece has lower temperature, which means that the heat exchange speed is faster. Besides, the final constant temperature is 6.2° C. lower than which of the aluminum without coated with the thermal conductive layer in the present invention. It shows that the thermal conductive layer of the present invention is capable of transferring the surface temperature to the surrounding medium (it is air in the present invention).

The thermal conductive coating layer of present invention is able to achieve a faster heat transmitting, bigger surface area, higher heat radiation and increasing the thermal disperse effect through the property of the boron nitride. It can be applied on the surface of the heat sink or the backboard of the LCD module, which is able to lower the element temperature effectively and stable the operating of the microelectronic elements in a working temperature, then further extending the usage lifetime.

### Other Embodiments

The preferred embodiments of the present invention have been disclosed in the examples. All modifications and alterations without departing from the spirits of the invention and appended claims, including the other embodiments shall remain within the protected scope and claims of the invention.

Although the preferred embodiments of the present invention have been disclosed in the examples, however the examples should not be construed as a limitation on the actual applicable scope of the invention, and as such, all modifications and alterations without departing from the spirits of the invention and appended claims, including the other embodiments shall remain within the protected scope and claims of the invention.

What is claimed is:

1. A thermal conductive coating layer, comprising:
30-70% (w/w) boron nitride; and
30-70% (w/w) binding reagent.

2. The coating layer of claim 1, wherein said coating layer comprises:
40-60% (w/w) boron nitride; and
40-60% (w/w) binding reagent.

3. The coating layer of claim 1, wherein said binding reagent comprises thermoplastic resins, thermo-setting resins or the mixture thereof.

4. The coating layer of claim 3, wherein said resin comprises epoxy resin, phenolric resin, acrylic resin, polystyrene resin or the mixture thereof.

5. A composition of the thermal conductive coating layer, comprising:
1-45% (w/w) boron nitride;
1-45% (w/w) binding reagent; and
a solvent.

6. The composition of claim 5, which comprises:
1-45% (w/w) boron nitride;
1-30% (w/w) binding reagent; and
a solvent.

7. The composition of claim 6, which comprises:
1-20% (w/w) boron nitride;
1-20% (w/w) binding reagent; and
a solvent.

8. The composition of claim 5, wherein said binding reagent comprises thermoplastic resins, thermo-setting resins or the mixture thereof.

9. The composition of claim 8, wherein said resin comprises epoxy resin, phenolric resin, acrylic resin, polystyrene resin or the mixture thereof.

10. The composition of claim 5, wherein said solvent is water or inert organic solvent.

11. A method for preparing a thermal conductive coating layer, comprising the following steps:
a) obtaining the composition of claim 5;
b) forming a coating layer of said composition on a substrate surface; and
c) drying said coating layer.

12. The method of claim 11, wherein said coating layer comprises a forming method of spray coating, brush coating or immersing.

13. The method of claim 11, wherein said drying is performed by a method of heating or air-drying.

14. The method of claim 11, wherein said substrate comprises metal or polymer.

15. The method of claim 11, wherein said metal comprises copper, aluminum or iron.

16. The method of claim 11, wherein said polymer comprises ABS or PC
